(19) United States
(12) Patent Application Publication
(10) Pub. No.: US 2009/0313079 A1
(43) Pub. Date: Dec. 17, 2009

(54) MANAGING ACCESS RIGHTS USING PROJECTS

(75) Inventor: Mark Frederick Wahl, Austin, TX (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/465,677

(22) Filed: May 14, 2009

Related U.S. Application Data
(63) Continuation-in-part of application No. 12/363,505, filed on Jan. 30, 2009.
(60) Provisional application No. 61/061,017, filed on Jun. 12, 2008.

(51) Int. Cl. G06Q 10/00

(52) U.S. Cl. 705/9; 705/7; 705/8

(57) ABSTRACT

Aspects of the subject matter described herein relate to managing access rights. In aspects, projects may be created from templates. The projects indicate one or more roles and one or more resources. The roles indicate access rights of entities associated with the roles. The projects may include events at which access rights change. Using the projects and independent role information, effective access rights to various resources may be determined for one or more entities. These effective access rights may be exported to one or more access control components to control access to the resources. The project and role information may also be used for auditing.

### BACKGROUND

Organizations that have many employees often have many computer-related resources. Such organizations may have employee turnover to a greater or lesser degree. As new employees are hired, these employees need to be granted access to computer-related resources. Likewise, as employees leave the organization, access rights need to be revoked. Even when an organization has relatively little turnover, employees within the organization may need different access rights at different times during their involvement within the organization.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to managing access rights. In aspects, projects may be created from templates. The projects indicate one or more roles and one or more resources. The roles indicate access rights of entities associated with the roles. The projects may include events at which access rights change. Using the projects and independent role information, effective access rights to various resources may be determined for one or more entities. These effective access rights may be exported to one or more access control components to control access to the resources. The project and role information may also be used for auditing.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary environment in which aspects of the subject matter described herein may be implemented;

FIG. 3 is a block diagram that represents an apparatus configured in accordance with aspects of the subject matter described herein;

FIG. 4 is a flow diagram that generally represents exemplary actions that may occur in managing access rights in accordance with aspects of the subject matter described herein; and

FIG. 5 is a flow diagram that generally represents exemplary actions that may occur in auditing in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” Other definitions, explicit and implicit, may be included below.

### Exemplary Operating Environment

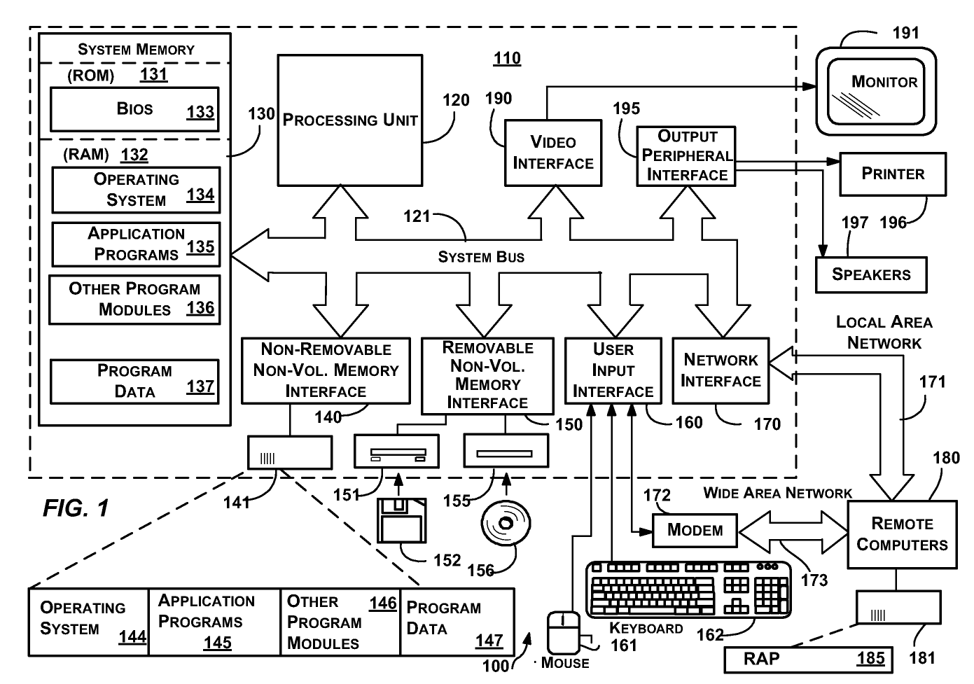

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, or configurations that may be suitable for use with aspects of the subject matter described herein comprise personal computers, server computers, hand-held or laptop devices, multiprocessor systems, microcontroller-based systems, set top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 20 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Access Management

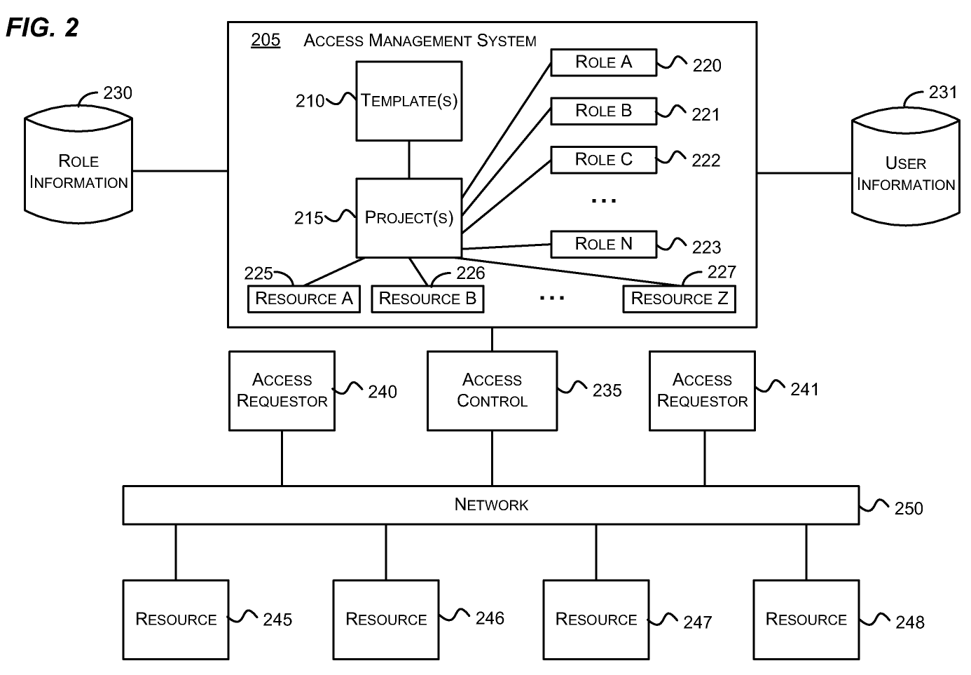

As mentioned previously, organizations often need to grant, revoke, or otherwise manage access rights to resources. FIG. 2 is a block diagram representing an exemplary environment in which aspects of the subject matter described herein may be implemented. The environment may include an access management system 205, stores 230-231, access control components 235, access requesters 240-241, resources 245-248, a network 250, and may include other entities (not shown). The access management system 205 may include one or more templates 210, one or more projects 215, one or more roles 220-223, and one or more resource indicators 225-227.

The various entities illustrated in FIG. 2 may be located relatively close to each other or may be distributed across the world. The various entities may communicate with each other via various networks including intra- and inter-office networks and the network 250.

Each of the various entities may be implemented as one or more components. As used herein, the term component is to be read to include all or a portion of a device, one or more software components executing on one or more devices (e.g., the computer 110 of FIG. 1), some combination of one or more software components and one or more devices, and the like.

In an embodiment, the network 250 may comprise the Internet. In an embodiment, the network 250 may comprise one or more local area networks, wide area networks, direct connections, virtual connections, private networks, virtual private networks, some combination of the above, and the like.

As illustrated in FIG. 2, the access management system 205 includes one or more templates 210. A template defines the structure of a project. In one embodiment, a template does this, in part, by indicating the roles and resources that are to be included in a project, the roles and resources that may be included in a project, or the roles and resources that are not to be included in a project. For example, the template may indicate that projects created from the template may include any resources that have a risk level of low. As another example, the template may indicate that projects created from the template cannot include any resource with a risk level of high. The template may also include additional rules about a project that may be used to create a project from the template.

A project associates one or more entities with roles and resource identifiers. A role indicates access rights that a set of one or more entities are to have for one or more resources identified by the resource identifiers.

Sometimes, the word “user” or its variants is used herein in conjunction with projects or roles. A user is a type of entity. Although entities include users, entities are not limited to users. When the word “user” or its variants is/are used in conjunction with projects or roles, in at least one embodiment, the original wording is to remain. In at least one other embodiment, the word “entity” or its appropriate variant is to be substituted for the phrase “user” or its variant.

In one sense, a role is a label that may be associated with one or more entities. For example, an employee may be involved in sales, marketing, management, engineering, maintenance, finance, or the like. In this sense, the employee may be said to act as a salesman, a market researcher, a manager, an engineer, on a maintenance team, in accounting, or the like. A single entity may be associated with more than one role. For example, an employee may be involved in sales and management.

A role may be associated with a set of access rights. For example, a developer role may be associated with access rights for a set of development machines, networks, development tools, and buildings to which the machines are housed. As another example, an accountant role may be associated with access rights to financial records, programs, and other resources. As yet another example, a bank teller role may have access to view customer accounts while not having access to create new customer accounts.

A role may be classified as a “fine-grained” role or a “coarse-grained” role. A coarse-grained role may include a role that is associated with a user outside of any project. For example, an employee in the sales department may be associated with a sales role outside of any project in which the employee may be involved. A fine-grained role may be a role that is associated with a user inside the context of a project. For example, a user may be associated with an owner role of a project.

Coarse-grained roles may be associated with a set of access rights that are independent of any projects. For example, a user with a finance role may have access to certain financial records and system independently of whether the user is part of an audit project. Coarse-grained roles may be associated with users based on user information found in the store 231. For example, if the user information indicates that a user works in the human resources department, the user may be associated with a human resources role.

A project may be associated with one or more roles. For example, a project may be associated with an owner role, an approver role, a reviewer role, and a participant role. Each project role may be associated with a single user or a set of users. A role may be associated with the set of users by selecting certain users (e.g., via a user interface), selecting groups of users (e.g., via a user interface), specifying rules regarding attributes of users to associate with a role, combinations of the above, and the like.

For example, a role may be associated with a set of users by indicating attributes of those individuals as found in the store 231. For example, a role may indicate that all vice presidents in development are associated with the role. As another example, a role may indicate that all employees over forty years old with five years at the company are associated with a role. As yet another example, a role may indicate that all employees that work in building 11 are associated with the role.

A project may be associated with one or more resource indicators 225-227. A resource indicator may indicate resources associated with a project. A resource may include all or a portion of a document, program, network, machine, facility, memory, power, data, combinations of the above, and the like. For example, a resource indicator may include the uniform resource locator of a protected file on a web site. A resource indicator may include references to one or more roles, references to one or more resources, and access rights that are to be granted to the one or more resources.

A project may have a start time and an end time. The access rights of users in one or more roles associated with the project may be valid between the start time and end time or a portion thereof. Access rights may be granted to users in one or more roles associated with the project when the start time occurs and may be revoked from one or more of those users when the end time occurs. A project may be terminated earlier than its end time. When a project is terminated earlier than its end time, access rights may be revoked at termination.

A project may be associated with zero or more events. Events may be paired. For example, a start event may be associated with an end event. At each event, the access management system 205 may determine whether the event affects any access rights for any users. If so, the access management system 205 may export access control information that reflects the access rights granted and/or revoked in response to the event occurring. In addition, in conjunction with an event occurring and/or at other times, the access management system 205 may determine whether to change the state of a resource. For example, in a project tracking the state of a deal with a resource consisting of a file of the deal terms, when the deal is finalized, the access management system 205 may place the resource in a read-only state.

The access management system 205 may be used to determine whether a resource is needed anymore. For example, if the access management system 205 determines that a resource is no longer involved in any projects, the access management system 205 may determine that the resource may be deleted, archived, or that other actions are to be taken with respect to the resource.

The access management system 205 may combine access rights indicated by one or more projects together with access rights associated with coarse-grained roles in the store 230 to determine a set of access rights to grant to one or more users. Combining access rights for a user may involve, for example, taking a union of the access rights indicated by the zero or more projects that include the user together with the access rights associated with zero or more coarse-grained roles in the store 230 that are associated with the user.

To control access, the access management system 205 may export access rights information to various access control components. For example, the access management system 205 may insert rows in databases that control access to certain resources, may provide data to directory services that control access to certain resources, may inform a rights-aware application of access rights to resources, may configure other access control mechanism(s), or the like.

The data exported may be tailored to the particular access control mechanism. For example, the access management system 205 may provide user identifiers of users who can access a resource, the resource identifier, and the access rights of the users to the resource, to a directory service component that uses this information to control access to resources. As another example, the access management system 205 may generate a row in a database table to indicate access rights of a user to a resource to another access control component.

The access control components 235 represent the various access control components with which the access management system 205 may communicate to control access to various resources. One or more of the access control components 235 may be grouped together. Two or more of the access control components 235 may be located in different places near or far from other access control components as needed or desired.

The access control components 235 may operate to control (e.g., allow, deny) access to the resources 245-248. When an access requester (such as one of the access requesters 240-241) requests access to one of the resources 245-248, an access control component (e.g., one or more of the access control components 235) may determine whether the requester is to be given access to the requested resource. If the requester is to be given access, the access control component(s) may grant or otherwise allow access to the requested resource. The access control components 235 may determine whether to grant access based on the information previously exported by the access management system 205.

Information in the access management system 205 may also be used for auditing purposes. For example, the access management system 205 may use its knowledge of projects together with access information indicated by the role information in the store 230 to determine and report on why an entity was given access to a particular resource at a particular time. In determining why an entity was given access, the access management system 205 may scan through projects that were active during the access as well as role information in the store 230. The access management system 205 may determine and report the one or more projects and/or roles that that allowed the entity to have access to the resource.

Although the environments described above includes various numbers of the entities and related infrastructure, it will be recognized that more, fewer, or a different combination of these entities and others may be employed without departing from the spirit or scope of aspects of the subject matter described herein. Furthermore, the entities and communication networks included in the environment may be configured in a variety of ways as will be understood by those skilled in the art without departing from the spirit or scope of aspects of the subject matter described herein.

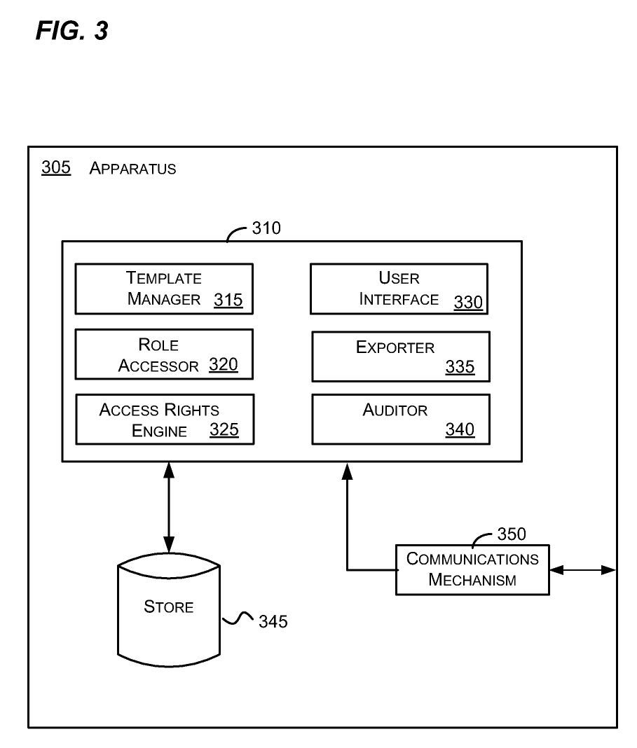

FIG. 3 is a block diagram that represents an apparatus configured in accordance with aspects of the subject matter described herein. The components illustrated in FIG. 3 are exemplary and are not meant to be all-inclusive of components that may be needed or included. In other embodiments, the components and/or functions described in conjunction with FIG. 3 may be included in other components (shown or not shown) or placed in subcomponents without departing from the spirit or scope of aspects of the subject matter described herein. In some embodiments, the components and/or functions described in conjunction with FIG. 3 may be distributed across multiple devices.

Turning to FIG. 3, the apparatus 305 may include access management components 310, a store 345, a communications mechanism 350, and other components (not shown). The apparatus 305 may be implemented as a computer (e.g., as the computer 110 of FIG. 1).

The access management components 310 may include a template manager 315, a role accessor 320, an access rights engine 325, a user interface 330, an exporter 335, an auditor 340, and other components (not shown). As used herein, the term component is to be read to include all or a portion of a device, one or more software components executing on one or more devices, some combination of one or more software components and one or more devices, and the like.

The communications mechanism 350 allows the apparatus 305 to communicate with other entities (e.g., the entities described in conjunction with FIG. 2). The communications mechanism 350 may be a network interface or adapter 170, modem 172, or any other mechanism for establishing communications as described in conjunction with FIG. 1.

The store 345 is any storage media capable of storing data. The term data is to be read broadly to include anything that may be operated on by a computer. Some examples of data include information, program code, program state, program data, other data, and the like. The store is operable to provide access to one or more projects. A project may indicate one or more resources, roles, and entities where the roles indicate access rights that the entities have to the resources.

The template manager 315 is operable to access templates and to indicate resources and roles needed for any projects that are derived from the templates. Access as used herein may include reading data, writing data, deleting data, updating data, a combination including one or more of the above, and the like.

The role accessor 320 is operable to obtain coarse-grained roles associated with the entities. The course-grained roles indicate access rights that are independent of the access rights indicated by roles of any project.

The access rights engine 325 is operable to combine the access rights indicated by the projects and the access rights indicated by the course-grained roles. The access rights engine 325 may determine, for each entity, effective access rights to one or more resources. For an entity and a particular resource at a particular time, the effective access rights to the resource are the access rights that result from combining (e.g., via a union) access rights to the resource to the entity from any project active at that time with access rights to the resource from any coarse-grained roles associated with the entity.

The user interface 330 is operable to receive an indication of entities to fill roles in a project. The user interface 330 may also be operable to receive an indication of a template for use in creating the project. The user interface 330 may also be used to display a report that audits access to one or more resources.

The exporter 335 is operable to send effective access rights to one or more access control components responsible for controlling access to the resources. For example, referring to FIG. 2, the exporter 335 may export effective access rights to the access control components 235.

The auditor 340 is operable to perform actions including:

1. Receiving an indication of an access to a resource by an entity where the access is granted to the entity. Receiving an indication of an access may comprise receiving an identifier of the entity, an identifier of the resource, and a time at which the access occurred.

2. Identifying zero or more projects associated with the entity.

3. Identifying role information, if any, associated with the entity. The role information indicates access rights associated with the entity independent of access rights associated with the entity via the zero or more projects.

4. Providing a report that indicates all projects, if any, and all roles, if any, from which access rights to the resource are derived. The auditor 340 may provide this report via the user interface 330, through an e-mail, via a file, or otherwise without departing from the spirit or scope of aspects of the subject matter described herein. The roles mentioned in this paragraph are the coarse-grained roles indicated by the role information.

In one embodiment, the auditor 340 may use only those projects that were active during the time of the access. Projects that were active during the time of the access may include projects that have a start time before or at the time the access occurred and an end time at or after the time the access occurred. For auditing purposes, active projects may also include projects that have an end time that is before the time the access occurred, if, for example, revocation of access rights has not or may have not been exported to the access control components (e.g., through some delay in propagating access right revocation). In these cases, a project may be said to be active if the project has a start time before or at the time of the access time and an end time plus propagation delay at or after the access time.

The auditor 340 may also participate in other auditing activities to determine why an entity was granted access to a particular resource.

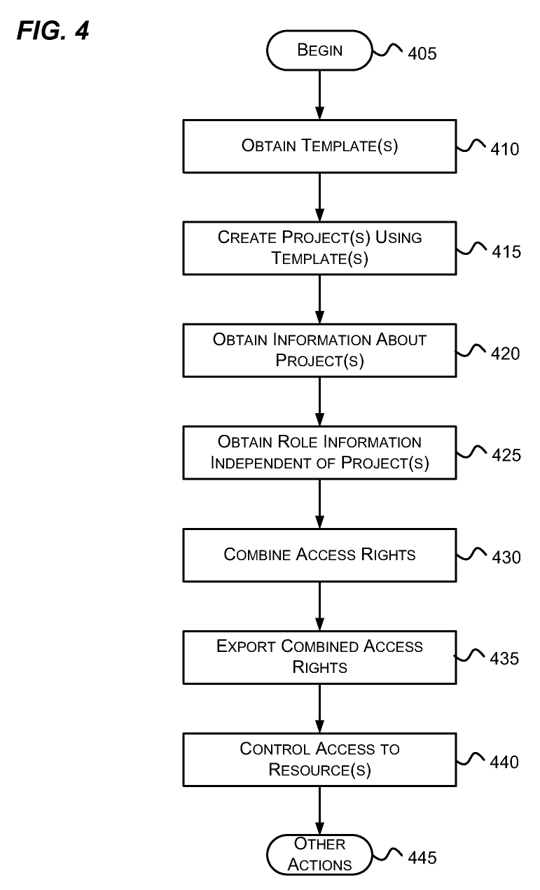

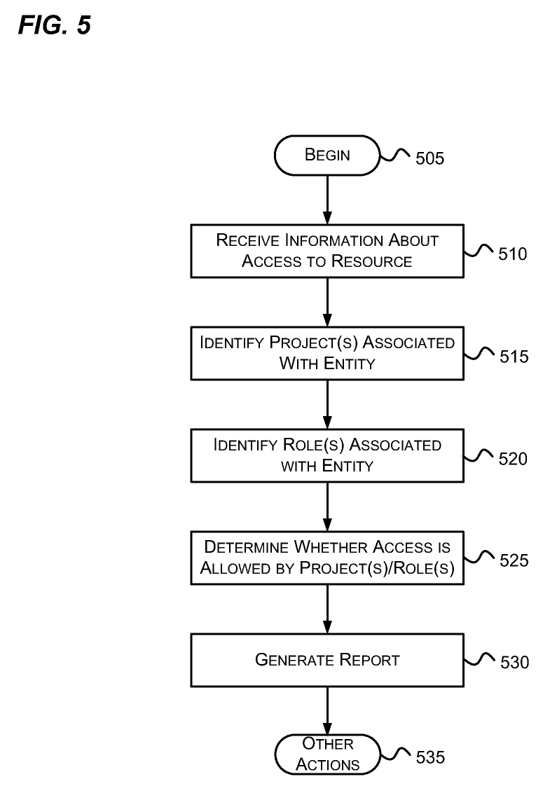

FIGS. 4-5 are flow diagrams that generally represent actions that may occur in accordance with aspects of the subject matter described herein. For simplicity of explanation, the methodology described in conjunction with FIGS. 4-5 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

FIG. 4 is a flow diagram that generally represents exemplary actions that may occur in managing access rights in accordance with aspects of the subject matter described herein. Turning to FIG. 4, at block 405, the actions begin.

At block 410, a template is obtained. For example, referring to FIG. 3, the template manager 315 may obtain a template from the store 345.

At block 415, a project is created using the template. For example, referring to FIG. 3, the user interface 330 presents graphical elements that allow a user to select entities to associate with roles of a project. The user interface 330 may also allow a user to specify a start time, end time, and other events regarding a project. Upon entering project information, information about the project may be saved to the store 345.

At block 420, information about one or more projects is obtained. A project indicates one or more resources roles, and entities associated with the project. The roles indicate access rights to one or more resources for entities associated with the roles.

As mentioned previously, a project may have a start time and an end time. Obtaining information regarding one or more projects may include obtaining start times and end times of the projects. As previously described, an access control component may be configured to grant access to a resource indicated by one or more projects during the time intervals between the start time and end time of each those projects, and to deny access to the resource after the end time of a project occurs if there are no other projects granting access to that resource at that time. This may be done, for example, by configuring the access control component when the start time of each project occurs and re-configuring the access control component when the end time of each project occurs.

In addition, access rights derived from a project may be determined in response to an event occurring. Obtaining information regarding the one or more projects may also include obtaining event information.

At block 425, the role information that is independent of the projects is obtained. For example, referring to FIG. 2, role information from the store 230 may be obtained. This role information is said to be “independent” of the projects as it specifies access rights associated with entities regardless of whether these access rights are also given those access rights via one or more roles of one or more projects. As previously described, these access rights may correspond to coarse-grained roles.

At block 430, the access rights indicated by the project roles and the role information are combined to determine combined access rights of the entities to the resources. For example, referring to FIG. 2, the access management system 205 may combine access rights indicated by role information in the store 230 with access rights indicated by roles 220-223 associated with projects 215 to determine effective access rights for one or more entities.

As a note, combined access rights may be determined for each entity and the combined access rights for one entity may be different than the combined access rights for another entity. For example, combining access the access rights may include for each entity, determining a union of all access rights associated with the entity from all active projects involving the entity and any role information, if any, associated with the entity.

At block 435, the combined access rights are sent to one or more access control components. For example, referring to FIG. 2, the access management system 205 may configure the access control components 235 with the effective access rights.

At block 440, the access rights to resources are controlled via one or more access control components. For example, referring to FIG. 2, the access control components 235 may control access to the resources 245-248.

At block 445, other actions, if any, may be performed.

FIG. 5 is a flow diagram that generally represents exemplary actions that may occur in auditing in accordance with aspects of the subject matter described herein. Turning to FIG. 5, at block 505, the actions begin.

At block 510, information about an access to a resource is received. For example, referring to FIG. 3, the auditor 340 may receive an indication of access to a resource. The access information may include, for example, an identifier of the entity, an identifier of the resource, and a time at which the access occurred.

At block 515, zero or more projects associated with the entity are identified. For example, referring to FIGS. 2 and 3, the auditor 340 may determine zero or more projects 215 that are associated with the particular entity that access the resource. The auditor 340 may eliminate (or not consider) projects that were not active at the time of the access and which did not contribute any access rights information in use by access control components controlling access by the entity to the resource at the time of the access.

At block 520, role information, if any, associated with the entity is identified. This role information indicates access rights that are associated with the entity independently of access rights associated with the entity via the zero or more projects. For example, referring to FIGS. 2 and 3, the auditor 340 may identify roles that are associated with the entity and included in the role information of the store 230.

At block 525, a determination is made as to whether access is allowed by the access rights derived from the projects and/or the role information. For example, referring to FIG. 3, the auditor 340 may determine each project, if any, and each role, if any, which would have given the entity access to the resource at the time the access was given.

At block 530, a report may be generated. The report may indicate all projects, if any, and all roles, if any, from which access rights to the resource (by the entity at the time of the access) are derived. For example, referring to FIG. 3, the auditor may generate a report that indicates the projects, if any, and roles, if any, that allowed an entity to access a resource.

At block 535, other actions, if any, may be performed.

As can be seen from the foregoing detailed description, aspects have been described related to managing access rights. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
obtaining information regarding a set of one or more projects, the projects indicating resources, roles, and entities, the roles indicating access rights for entities associated with the roles;
obtaining role information that is independent of the projects, the role information indicating access rights associated with one or more of the entities; and
combining the access rights indicated by the roles indicated by the projects with the access rights indicated by the role information to determine combined access rights of the entities to the resources.

2. The method of claim 1, further comprising:
obtaining a template that indicates roles and resources that are to be included in a project created using the template; and
creating the project using the template.

3. The method of claim 2, wherein creating the project using the template comprises associating one or more entities with each of the roles indicated by the template.

4. The method of claim 1, wherein obtaining information regarding a set of one or more projects comprises obtaining a start time and an end time of at least one of the one or more projects and further comprising configuring one or more access control components to grant access to a resource after the start time occurs and to deny access to the resource after the end time occurs if there are no other projects granting access to the resource at the end time.

5. The method of claim 1, wherein obtaining information regarding a set of one or more projects comprises obtaining an indication of an event at which access rights derived from at least one of the one or more projects change.

6. The method of claim 5, further comprising determining access rights derived from the project in response to the event occurring.

7. The method of claim 1, wherein obtaining role information that is independent of the projects comprises obtaining information from a data structure that associates one or more of the entities with one or more roles, the data structure being independent of any of the projects.

8. The method of claim 1, further comprising exporting the combined access rights to one or more access control components responsible for controlling access to the resources.

9. The method of claim 1, wherein combining the access rights indicated by the roles indicated by the projects with the access rights indicated by the role information comprises, for each entity of the entities, determining a union of access rights, if any, indicated for the entity by roles of projects, and access rights indicated by other role information, if any, associated with the entity.

10. A computer storage medium having computer-executable instructions, which when executed perform actions, comprising:
receiving an indication of an access to a resource, the access granted to an entity;
identifying zero or more projects associated with the entity, the projects indicating resources, roles, and entities, the roles indicating access rights for entities associated with the roles;
identifying role information, if any, associated with the entity, the role information indicating access rights associated with the entity independent of access rights associated with the entity via the zero or more projects; and
determining whether the access is allowed by access rights derived from the projects and/or the role information.

11. The computer storage medium of claim 10, further comprising generating a report that indicates all projects, if any, from which access rights to the resource are derived.

12. The computer storage medium of claim 10, further comprising generating a report that indicates all roles, if any, of the role information from which access rights to the resource are derived.

13. The computer storage medium of claim 10, wherein identifying zero or more projects associated with the entity comprises identifying only those projects that were active during a time of the access.

14. The computer storage medium of claim 13, wherein identifying only those projects that were active during the time of the access comprises identifying each project that has a start time before or at the time of the access and an end time plus propagation delay at or after the time of the access, the project having a role associated with the entity.

15. The computer storage medium of claim 10, wherein receiving an indication of an access to a resource comprises receiving an identifier of the entity, an identifier of the resource, and a time at which the access occurred.

16. In a computing environment, an apparatus, comprising:
a store operable to provide access to one or more projects, the projects indicating resources, first roles, and entities, the first roles indicating access rights for entities associated with the first roles;
a role accessor operable to obtain second roles associated with the entities, the second roles indicating access rights that are independent of the access rights indicated by the first roles; and
an access rights engine operable to combine the access rights for entities associated with the first roles with the access rights indicated by the second roles to determine, for each of the entities, effective access rights to one or more resources.

17. The apparatus of claim 16, further comprising a template manager operable to access a template and to indicate resources and first roles needed for any projects derived from the template.

18. The apparatus of claim 16, further comprising an exporter operable to send the effective access rights to one or more access control components responsible for controlling access to the resources.

19. The apparatus of claim 16, further comprising an auditor operable to perform actions, comprising:
receiving an indication of an access to a resource, the access granted to an entity;
identifying zero or more projects associated with the entity;
identifying role information, if any, associated with the entity, the role information indicating access rights associated with the entity independently of access rights associated with the entity via the zero or more projects; and
providing a report that indicates all projects, if any, and all roles, if any, from which access rights to the resource are derived, the roles being indicated by the role information.

20. The apparatus of claim 16, further comprising a user interface operable to receive an indication of entities to fill first roles in a project, the user interface further operable to receive an indication of a template to use in creating the project.
